(19) United States
(12) Patent Application Publication
(10) Pub. No.: US 2014/0046858 A1
(43) Pub. Date: Feb. 13, 2014

(54) SYSTEM AND METHOD FOR FOSTERING SOCIAL CUSTOMER SERVICE

(71) Applicant: BEN WERNER, Bellevue, WA (US)

(72) Inventor: BEN WERNER, Bellevue, WA (US)

(73) Assignee: Oracle International Corporation, Redwood Shores, CA (US)

(21) Appl. No.: 13/571,005

(22) Filed: Aug. 9, 2012

(51) Int. Cl. G06Q 10/00

(52) U.S. Cl. 705/304

(57) ABSTRACT

Embodiments of the invention provide systems and methods for handling of customer service questions or requests within a customer relationship management system. According to one embodiment, a method of routing of customer service questions or requests within a customer relationship management system can comprise registering each of a plurality of users of the customer relationship management system. A customer service request may then be received from a user of the plurality of users. The customer service request can include a question. The request and the user making the request can be analyzed. Based on the analysis of the request and the user making the request, the request can be routed to at least one of predefined content of the customer relationship management system, an agent of the customer relationship management system, or a community comprising at least the registered plurality of users.

### BACKGROUND OF THE INVENTION

Embodiments of the present invention relate generally to methods and systems for providing customer service and more particularly to handling of customer service questions or requests within a customer relationship management system.

Customer Relationship Management (CRM) systems provide support for customers of a product or service by allowing those users to make requests for service that can include a question posed by the user related to the product or service. For example, a user may log onto or access a CRM system provided by a manufacturer of cellphones and request information related to use of that device and that may include a question such as “How do I adjust the brightness of the display?” Generally speaking, these systems receive requests for service, e.g., in the form of a phone call, web page form, instant message, email, etc., and route the requests to a human agent for addressing the request and providing an answer to the question. In many cases, the agent is selected based on the topic of the question or request and a predefined profile of that agent that includes indications of the agent's skills and/or expertise.

However, while existing CRM systems can base processing decisions on matching the expertise of the agents to the type of questions posed, they do not consider other factors affecting the efficiency of the system and/or the satisfaction of the users. For example, existing systems do not consider which interactions are suitable for which channels or dynamically consider the relative cost of addressing the requests in one way or another. They also do not consider the relative value of longtime customers or even agreements, i.e., Service Level Agreements (SLAs), that may be in place with different users. As a result, existing systems can be inefficient and even ineffective and can provide results that are unsatisfactory. Hence, there is a need for improved methods and systems for handling of customer service questions or requests in a customer relationship management system.

### BRIEF SUMMARY OF THE INVENTION

Embodiments of the invention provide systems and methods for handling of customer service questions or requests within a customer relationship management system. According to one embodiment, a method of routing of customer service questions or requests within a customer relationship management system can comprise registering each of a plurality of users of the customer relationship management system. A customer service request may then be received from a user of the plurality of users. The customer service request can include a question. The request and the user making the request can be analyzed. Based on the analysis of the request and the user making the request, the request can be routed to at least one of predefined content of the customer relationship management system, an agent of the customer relationship management system, or a community comprising at least the registered plurality of users. For example, analyzing the request and the user making the request can comprise determining a relative economic cost associated with routing the request to each of the predefined content, the agent of the customer relationship management system, or the community comprising at least the registered plurality of users. Routing the request can then be based on the relative economic cost.

Additionally or alternatively, analyzing the request can comprise determining whether the question is related to the predefined content. In response to determining the question is related to the predefined content, the predefined content can be provided to the user in response to the request. In response to determining the question is not related to the predefined content, a complexity of the question can be determined and a complexity score can be assigned to the request based on the determined complexity of the question. In such cases, determining the relative economic cost associated with routing the request to each of the predefined content, the agent, or the community can be based at least in part on the assigned complexity score. In some cases, analyzing the request and the user making the request can also comprise determining a customer lifetime value for the user making the request and assigning a relative importance to the request based on the customer lifetime value.

For example, one or more rules can be applied to the request based on the complexity score and relative importance assigned to the request. The request can then be routed to the agent or community based on applying the one or more rules. In some cases, a determination can be made as to whether the question has been answered. In response to determining the question has not been answered, applying one or more rules to the request based on the complexity score and relative importance assigned to the request and routing the request to the agent or community based on applying the one or more rules can be repeated, for example, until the question is answered.

According to one embodiment, an award value can be assigned to the request. The award value can represent an award to be provided to a user of the community providing an answer to the question of the request. In such cases, determined relative economic cost associated with routing the request to the community can include the award value. In response to determining to route the request to the community, the question and the award can be presented to the users of the community.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for routing of customer service questions or requests within a customer relationship management system according to one embodiment of the present invention.

FIG. 4 is a flowchart illustrating a process for routing of customer service questions or requests within a customer relationship management system according to one embodiment of the present invention.

FIG. 5 is a flowchart illustrating additional details of a process for routing of customer service questions or requests within a customer relationship management system according to one embodiment of the present invention.

FIG. 6 is a flowchart illustrating additional details of process for routing of customer service questions or requests to a community of users of a customer relationship management system according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for routing of customer service questions or requests within a customer relationship management system. More specifically, embodiments of the present invention provide for processing of requests for service such as in a Customer Relationship Management (CRM) system. The CRM system can support a number of users, such as end users of a product or service, can receive requests for support or service from those users, and process those requests in order to provide the requesting users with answers to questions posed in the requests. For example, processing the requests may include providing one or more predefined answers to a presented question if the question is common or at least answered before. In other cases, processing the requests can include evaluating the question and the user presenting the question and routing or handling the request based on this evaluation in order to address the request in a manner that considers any of a number of different factors including but not limited to the relative difficulty of the question (i.e., measured through complexity), the relative importance of the user making the request and any agreements in place with that user, the relative cost and/or efficiency of handling the request in different ways, etc. Handling the request can include providing the predefined answers mentioned above and/or selectively routing the request to an agent, such as a human operator, or a community of registered users of the system.

According to one embodiment, when the system routes a question to the community of users, an incentive, e.g., a monetary award, non-monetary preference or status points, discounts, prizes, etc., can be added as an incentive to be awarded to the user of the community who first provides a satisfactory answer to the question provided. The amount and/or type of incentive can depend upon the difficulty or complexity of the question presented and the user making the request, e.g., based on and any status achieved by that user or any service level agreement, etc. with that user. When such an incentive is provided, a value of this incentive can be considered as one factor, i.e., a cost, when deciding how to handle or route the request. Various additional details of embodiments of the present invention will be described below with reference to the figures.

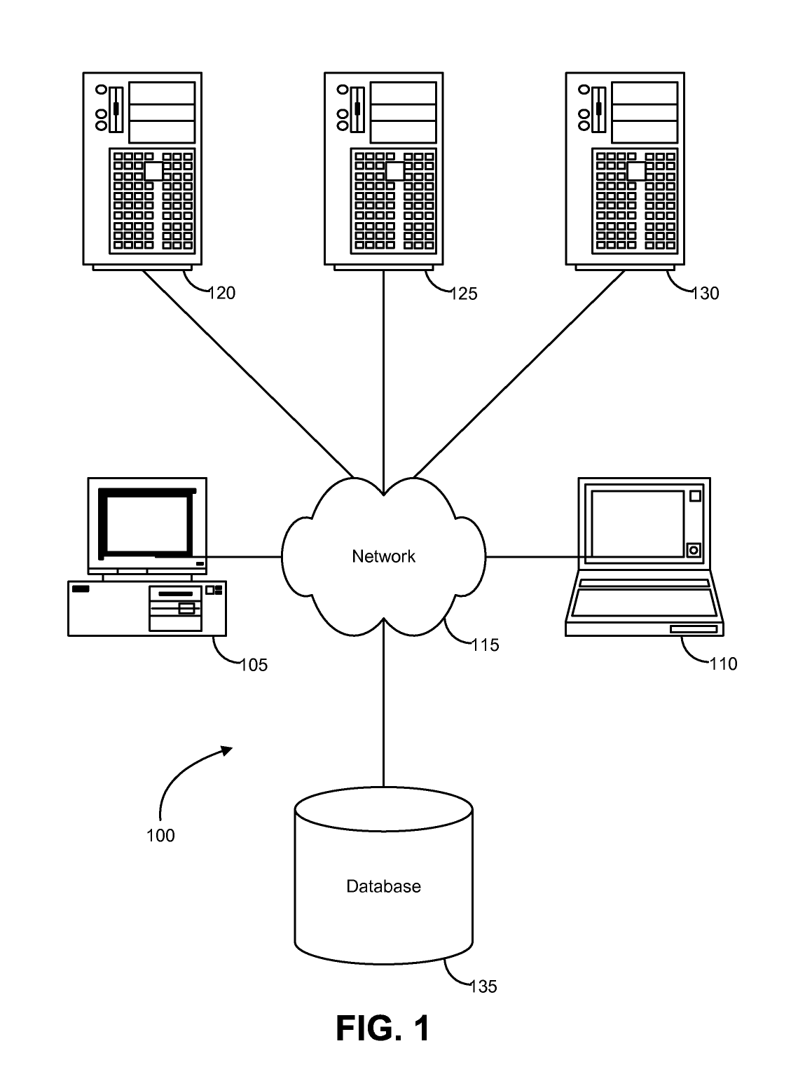

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

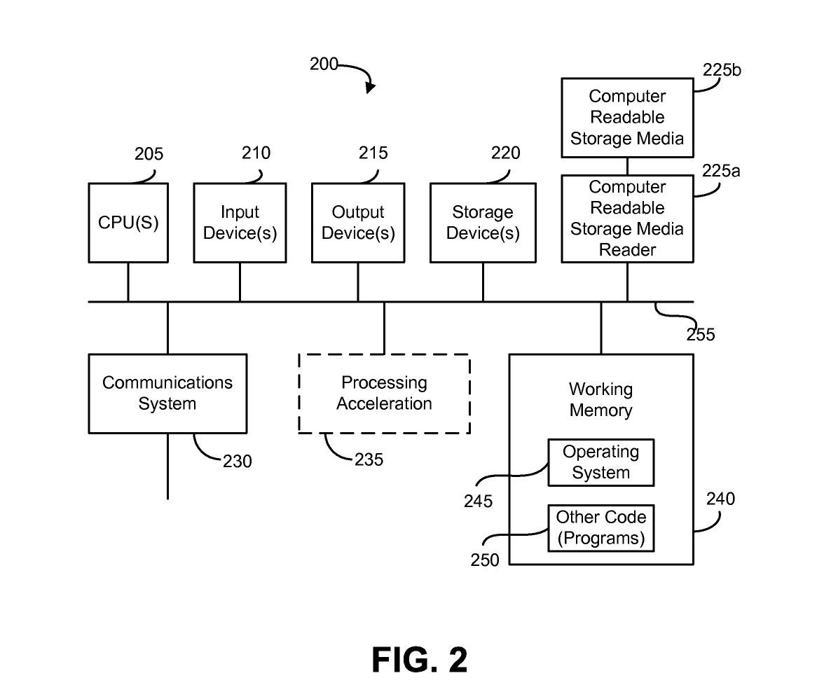

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

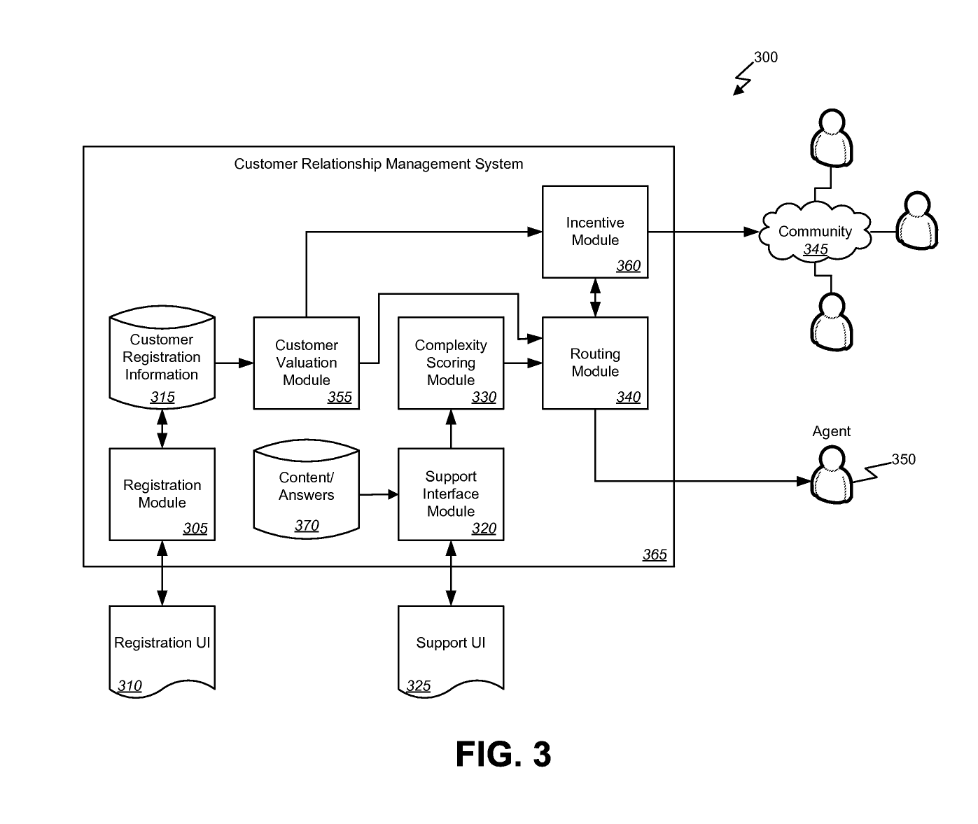

FIG. 3 is a block diagram illustrating, at a high-level, functional components of a system for routing of customer service questions or requests within a customer relationship management system according to one embodiment of the present invention. In this example, the system 300 includes a Customer Relationship Management (CRM) System such as may be executed on a server or another computer or computing device as described above. Generally speaking, the CRM system can support a number of users, such as end users of a product or service, can receive requests for support or service from those users, and process those requests in order to provide the requesting users with answers to questions posed in the requests. For example, processing the requests may include providing one or more predefined answers to a presented question if the question is common or at least answered before. In other cases, processing the requests can include evaluating the question and the user presenting the question and routing or handling the request based on this evaluation in order to address the request in a manner that considers any of a number of different factors including but not limited to the relative complexity of the question, the relative importance of the user making the request and any agreements in place with that user, the relative cost and/or efficiency of handling the request in different ways, etc. Handling the request can include providing the predefined answers mentioned above and/or selectively routing the request to an agent 350 such as a human operator, or a community 345 of registered users of the CRM system 365.

According to one embodiment, when the CRM system 365 routes a question to the community of users 345, an incentive, e.g., a monetary award, non-monetary preference or status points, discounts, etc., can be added as an incentive to be awarded to the user of the community 345 who first provides a satisfactory answer to the question provided. The amount and/or type of incentive can depend upon the difficulty or complexity of the question presented and the user making the request, e.g., based on and any status achieved by that user or any service level agreement, etc. with that user. When such an incentive is provided, a value of this incentive can be considered as one factor, i.e., a cost, when deciding how to handle or route the request.

More specifically, the CRM system 365 can include a registration module 305 that presents a registration user interface 310 such as one or more web pages presented over the Internet or other wide area or local area network as described above. Through such an interface 310 customers of an entity operating the CRM system 365 or for which the CRM system is operated, can register via the web or mobile device before receiving support or otherwise interacting with the CRM system 365. The registration module 305 can collect information from the user through the registration user interface 310 and generate a record to be stored in a repository of customer registration information 315.

After registering, the user can then access the CRM system 365 to request support. For example, the registered customer can access a support user interface 325 such as one or more web pages presented over the Internet or other wide area or local area network as described above by a support interface module 320 of the CRM system 365. Through the support user interface 325, registered users can ask their question or describe their problem and submit their requests for support. At this point, the CRM system 365 can process the request and determine how to best handle the request based on the user making the request and the question or questions presented in the request. As introduced above, the request can be handled by providing some predefined content 370 to the user or routing the user to an agent 350 or a community 345 of other registered users as will be described in greater detail below.

So for example, upon receiving a request from a user through the support user interface 320, a determination can be made by the support interface module 320 as to whether there already exists content predefined in the repository content 370 that “matches” or is relevant to the question(s) posed in the user's request. This determination can be based on parsing and analyzing (i.e., grammatical and/or lexical analysis such as Gunning-Fog or Flesch Kincaid analysis for example) of the received question and attempting to match the content and meaning of the question to metadata associated with the content. The content can be considered matching with the question if found to be within a predefined degree of relevance or found to have a certain minimum matching score using a variety of different possible approaches as can be understood by one of skill in the art.

If the user's question can be algorithmically matched to an existing piece of content 370, matching content documents can then be shown to the user by the support interface module 320 through the support user interface 325. When the user is presented with or views one of these answer documents, they can be presented with a modal dialog such as “Did this information answer your questions? Yes/No” before returning to the originating page of the support user interface 325. If the user answers Yes or closes the support user interface 325, the CRM system 365 can measure a successful self-service deflection. If the user answers “No”, the user can be brought back by the support interface module 320 to a list of remaining potential answer documents, with the unhelpful answer removed from the list presented in the support user interface 325. In some implementations, rather than a yes or no answer, user feedback can be indicated on a scale. For example, this can be done on a 5 point Likert scale where a score of less than 2 is handled the same as “no” answer. At this point, the user may choose to view another answer or click a button of the interface 325 that says “None of these answer my question”. After clicking this button, an incident recorded can be created in the CRM system 365.

If there is found to be no matching content 370 or the user has indicated that presented content does not satisfactorily answer the question, further processing of the request may be performed by the CRM system 365. This processing can include a complexity scoring module 330 of the CRM system 365 parsing, analyzing, i.e., grammatically and/or lexically, and scoring the complexity of the received question using a variety of techniques as can be understood by one of skill in the art. In addition to the complexity score, a customer lifetime value (CLV) calculation can be performed by the customer valuation module 355 periodically or on demand for the user to determine an importance of the user relative to other registered users. According to one embodiment, the CLV can be pre-computed periodically and stored for reference as needed when processing requests. For example, if the user has accumulated a particular status based on revenues or other factors or has a Service Level Agreement (SLA) in place, that user can be rated or ranked more highly and thus given preference or priority over other users without such an SLA or status.

Based on the complexity score generated by the complexity scoring module 330 and the relative importance or value of the user making the request as determined by the customer valuation module 355, a routing module 340 of the CRM system 365 can determine how to further direct the user's request/question. For example, the routing module 340 can determine to route the user to an agent 350 or a community 345 of other registered users. In addition to the complexity score and the user's rating, the routing module can consider the relative cost of routing the request to the agent 350 verses routing the request to the community 345. That is, the community may present a much lower cost than the agent but the complexity of the question or the status of the user may be such as to justify routing the request to an agent 350.

According to one embodiment, when routing a request to the community 345, an award or incentive may be assigned to the question by the incentive module 360 of the CRM system 365. This incentive may be a monetary or non-monetary prize, e.g., cash, status or preference points that may influence a user's future value calculations, discounts, etc., awarded to a user of the community 345 who first provides a satisfactory answer to the presented question. The value of this incentive can be determined by the incentive module based in part on the value or importance of the requesting user as determined by the customer valuation module and/or the complexity of the question as determined by the complexity scoring module 330. The value of the incentive can also be considered by the routing module 340 as a cost of routing to the community 345 when determining how to handle a particular request. When a decision is made to route a question to the community 345, the question along with the associated award or incentive can be displayed or otherwise presented to the users of the community 345. In some cases, this incentive may be changes by the incentive module 360 over time, e.g., increased over time as the question remains pending. The amount and/or frequency of this increase may again depend upon the relative important of value of the requesting user and/or the complexity score for the question. Additionally, this changed award may influence routing by the routing module 340. That is, at some point, based on the passage of time only or as the award increases in value, the routing module 340 may re-route the pending question from the community 345 to a human agent 350.

According to one embodiment, when routing a request to an agent 350, an agent can be selected based on the nature of the question, i.e., subject matter, complexity score, etc., and predefined expertise of the particular agent(s) as can be understood by one skilled in the art. Additionally, a channel by which the agent can be contacted might be selected from a number of available channels, e.g., a voice phone call, email, text message, chat, instant message, etc. The selection of this channel may be based on a user request or pre-defined preference, a pre-defined agent preference for each of the available agents, terms of any SLA in place with the requesting user, or any of a number of other one or more considerations. Again, the value or cost associated with the particular channels can also be considered by the routing module 340 as a cost of routing to the agent 350 when determining how to handle a particular request and which channel to select.

So for example, based on the determined question complexity score and matching certain keywords against a pre-defined set of “categories,” the requesting user can then be shown a list of contact channels which are available to them and appropriate for the nature of their question. For instance, a high-complexity, low-volume question or a high-value user can be provided a more expensive but better first contact resolution channel such as phone or chat or even a choice between two or more such channels. If the customer chooses to use the phone, the higher value user can then be shown an easily memorable incident id, e.g., that uses a repeated consonant vowel consonant mnemonic to help the user keep the id in their short term memory. When this user begins their support channel experience, that user can be asked to input the id when beginning of the phone session so that the support system can automatically bring up the customer contact record, as well as their support web browsing history to see which answers the user has already looked at rated as unhelpful. If the user chooses chat or email, this data can be passed to the next system without requiring any memory load on the user. If the customer is of lower relative value, the inquiry may be sent to a queue where this issue appears associated with a monetary reward which is an approximation of the question complexity score, CLV calculation or SLA. If after some pre-defined period of time the user's question goes unanswered, the question may then be re-routed to a paid support representative to manually respond the customer's inquiry. When an answer is provided to the customer's inquiry, this content can be placed into the repository of content 370 where this knowledge can be proactively offered to solve future inquiries.

Stated another way, routing of customer service questions or requests within the CRM system 365 can begin with the registration module 305 registering each of a plurality of users of the CRM system 365. Once registered, a customer service request can be received from a user of the plurality of users through the support user interface 325 presented by the support interface module 320. For example, the customer service request can include a question to which the requesting user is seeking an answer. The request and the user making the request can be analyzed by the complexity scoring module 330 and customer valuation module 355. Analyzing the request and the user making the request can also comprise determining by the routing module 340 of the CRM system 365 a relative economic cost associated with routing the request to each of predefined content 370 of the CRM system 365, an agent 350 of the CRM system 365, or a community 345 comprising at least the registered plurality of users. The request can then be routed by the routing module 340 based on analyzing the request and the user making the request, i.e., based on the relative economic cost, to at least one of the predefined content 370, the agent 350, or the community 345.

More specifically, analyzing the request can comprise reading the question from the request and determining by the support interface module 320 whether the question is related to any of the predefined content 370, i.e., the same or a similar question has already been answered and that answer has been saved for future use. In response to determining the question is related to the predefined content 370, the predefined content can be provided by the support interface module 320 through the support user interface 325 in response to the request. A determination can then be made by the support interface module 320 as to whether the provided content answered the user's question, e.g., by receiving an acknowledgement from the user. If the provided content did answer the user's question, processing may end.

However, in response to determining by the support interface module 320 that the question is not related to the predefined content or in response to determining by the support interface module 320 that any predefined content that may have been provided did not answer the user's question, a determination can be made by the complexity scoring module 330 as to the complexity of the question and a complexity score can be assigned by the complexity scoring module 330 to the request based on the determined complexity of the question. As noted, this determination and score can be based on a grammatical and/or lexical analysis of the text of the question and/or by other possible means. Determining by the routing module 340 the relative economic cost associated with routing the request to each of the predefined content, the agent, or the community can be based at least in part on this assigned complexity score. In some implementations, the routing module 340 can additionally or alternatively function as a dynamic load balancer. For instance, if the phone channel is oversubscribed with a long wait time, the algorithm of the routing module 340 can adjust the weightings to offload more incoming interactions onto lower cost/more scalable channels.

Analyzing the request and the user making the request can also comprise determining by the customer valuation module 355 a customer lifetime value for the user making the request and assigning by the customer valuation module 355 a relative importance to the request based on the customer lifetime value. One or more rules can be applied by the routing module 340 to the request based on the complexity score and relative importance assigned to the request and the request can be routed by the routing module 340 to the agent 350 or community 345 based on applying the one or more rules. A determination can then be made by the routing module 340 as to whether the question has been answered by the agent or the community. In response to determining the question has not been answered, said applying one or more rules to the request based on the complexity score and relative importance assigned to the request and said routing the request to the agent or community based on applying the one or more rules can be repeated by the routing module 340, for example until an answer has been received. However, each repetition may apply a different rule or achieve a different result, e.g., routing the message to a different agent, assigning a higher score or value, etc., in attempts to achieve a better result with each iteration.

As noted above, a monetary or other award may be associated with a customer service request by the incentive module 360 of the CRM system 365 as an incentive for community members to assist in answering the question. In such cases, an award value can be assigned by the incentive module 360 to the request. The award value can represent the award to be provided to a user of the community 345 providing an answer to the question of the request and can be determined by the incentive module 360 based on any of a number of factors including but not limited to the determined complexity of the question and/or the customer lifetime value of the user presenting the question. Additionally, the determined relative economic cost associated with routing the request to the community 345 can include the award value. In response to determining by the routing module 360 to route the request to the community 345, the question and the award can be presented by the routing module 340 and/or incentive module 360 to the users of the community 345.

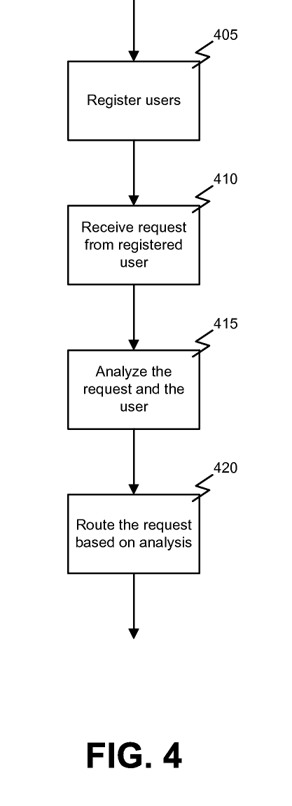

FIG. 4 is a flowchart illustrating a process for routing of customer service questions or requests within a customer relationship management system according to one embodiment of the present invention. In this example, routing of customer service questions or requests within a customer relationship management system can begin with registering 405 each of a plurality of users of the customer relationship management system. Once registered 405, a customer service request can be received 410 from a user of the plurality of users. For example, the customer service request can include a question to which the requesting user is seeking an answer. The request and the user making the request can be analyzed 415. More specifically, analyzing 415 the request and the user making the request can comprise determining a relative economic cost associated with routing the request to each of predefined content of the customer relationship management system, an agent of the customer relationship management system, or a community comprising at least the registered plurality of users. The request can then be routed 420 based on analyzing the request and the user making the request, i.e., based on the relative economic cost, to at least one of the predefined content, the agent, or the community.

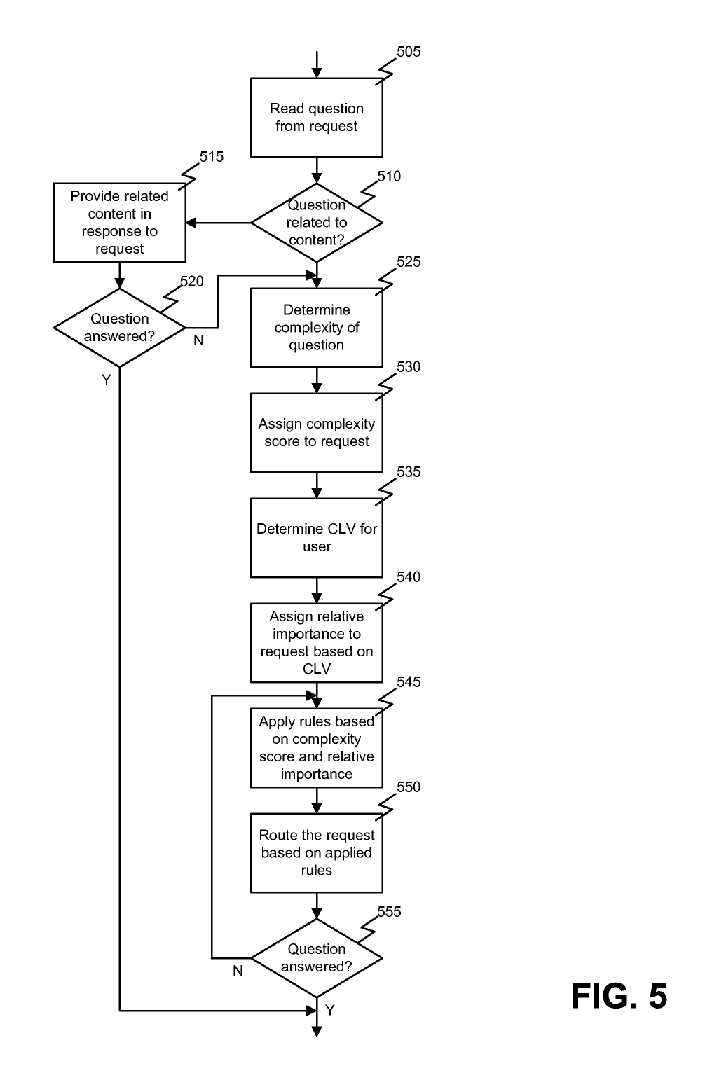

FIG. 5 is a flowchart illustrating additional details of a process for routing of customer service questions or requests within a customer relationship management system according to one embodiment of the present invention. More specifically, this example illustrates additional details of analyzing a customer service request. In this example, analyzing the request comprises reading 505 the question from the request and determining 510 whether the question is related to any of the predefined content, i.e., the same or a similar question has already been answered and that answer has been saved for future use. In response to determining 510 the question is related to the predefined content, the predefined content can be provided 515 in response to the request. A determination 520 can then be made as to whether the provided content answered the user's question, e.g., by receiving an acknowledgement from the user. If 520 the provided content did answer the user's question, processing may end.

However, in response to determining 510 the question is not related to the predefined content or in response to determining 520 any predefined content that may have been provided 515 did not answer the user's question, a determination 525 can be made of the complexity of the question and a complexity score can be assigned 530 to the request based on the determined 525 complexity of the question. As noted, this determination 525 and score can be based on a grammatical and/or lexical analysis of the text of the question and/or by other possible means. Determining the relative economic cost associated with routing the request to each of the predefined content, the agent, or the community can be based at least in part on this assigned complexity score.

Analyzing the request and the user making the request can also comprise determining 535 a customer lifetime value for the user making the request and assigning 540 a relative importance to the request based on the customer lifetime value. One or more rules can be applied 545 to the request based on the complexity score and relative importance assigned to the request and the request can be routed 550 to the agent or community based on applying the one or more rules. A determination 55 can then be made as to whether the question has been answered by the agent or the community. In response to determining 555 the question has not been answered, said applying 545 one or more rules to the request based on the complexity score and relative importance assigned to the request and said routing 550 the request to the agent or community based on applying the one or more rules can be repeated, for example until an answer has been received. However, each repetition may apply a different rule or achieve a different result, e.g., routing the message to a different agent, assigning a higher score or value, etc., in attempts to achieve a better result with each iteration.

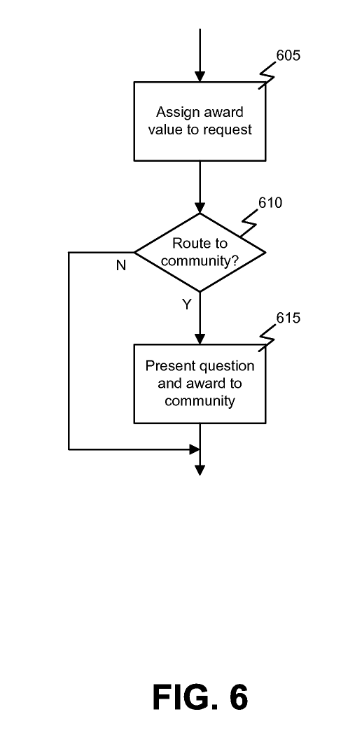

FIG. 6 is a flowchart illustrating additional details of process for routing of customer service questions or requests to a community of users of a customer relationship management system according to one embodiment of the present invention. As noted above, a monetary or other award may be associated with a customer service request as an incentive for community members to assist in answering the question. In such cases, an award value can be assigned 605 to the request. The award value can represent the award to be provided to a user of the community providing an answer to the question of the request and can be determined based on any of a number of factors including but not limited to the determined complexity of the question and/or the customer lifetime value of the user presenting the question. Additionally, the determined relative economic cost associated with routing the request to the community can include the award value. In response to determining 610 to route the request to the community, the question and the award can be presented 615 to the users of the community.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of routing of customer service questions or requests within a customer relationship management system, the method comprising:
registering each of a plurality of users of the customer relationship management system;
receiving a customer service request from a user of the plurality of users, the customer service request including a question;
analyzing the request and the user making the request; and
routing the request based on analyzing the request and the user making the request to at least one of predefined content of the customer relationship management system, an agent of the customer relationship management system, or a community comprising at least the registered plurality of users.

2. The method of claim 1, wherein analyzing the request and the user making the request comprises determining a relative economic cost associated with routing the request to each of the predefined content, the agent of the customer relationship management system, or the community comprising at least the registered plurality of users and wherein routing the request comprises routing the request based on the relative economic cost.

3. The method of claim 2, wherein analyzing the request comprises:
determining whether the question is related to the predefined content;
in response to determining the question is related to the predefined content, providing the predefined content in response to the request; and
in response to determining the question is not related to the predefined content, determining a complexity of the question and assigning a complexity score to the request based on the determined complexity of the question and wherein determining the relative economic cost associated with routing the request to each of the predefined content, the agent, or the community is based at least in part on the assigned complexity score.

4. The method of claim 3, wherein analyzing the request and the user making the request comprises determining a customer lifetime value for the user making the request and assigning a relative importance to the request based on the customer lifetime value.

5. The method of claim 4, further comprising:
applying one or more rules to the request based on the complexity score and relative importance assigned to the request; and
routing the request to the agent or community based on applying the one or more rules.

6. The method of claim 5, further comprising:
determining whether the question has been answered; and
in response to determining the question has not been answered, repeating said applying one or more rules to the request based on the complexity score and relative importance assigned to the request and said routing the request to the agent or community based on applying the one or more rules.

7. The method of claim 5, further comprising assigning an award value to the request, the award value representing an award to be provided to a user of the community providing an answer to the question of the request.

8. The method of claim 7, wherein the determined relative economic cost associated with routing the request to the community includes the award value.

9. The method of claim 7, further comprising, in response to determining to route the request to the community, presenting the question and the award to the users of the community.

10. A customer relationship management system comprising:
a processor; and
a memory communicatively coupled with and readable by the processor and having stored therein a sequence of instructions which, when executed by the processor, causes the system to route of customer service questions or requests by registering each of a plurality of users of the customer relationship management system, receiving a customer service request from a user of the plurality of users, the customer service request including a question, analyzing the request and the user making the request, and routing the request based on analyzing the request and the user making the request to at least one of predefined content of the customer relationship management system, an agent of the customer relationship management system, or a community comprising at least the registered plurality of users.

11. The system of claim 10, wherein analyzing the request and the user making the request comprises determining a relative economic cost associated with routing the request to each of the predefined content, the agent of the customer relationship management system, or the community comprising at least the registered plurality of users and wherein routing the request comprises routing the request based on the relative economic cost.

12. The system of claim 11, wherein analyzing the request comprises:
determining whether the question is related to the predefined content;
in response to determining the question is related to the predefined content, providing the predefined content in response to the request; and
in response to determining the question is not related to the predefined content, determining a complexity of the question and assigning a complexity score to the request based on the determined complexity of the question and wherein determining the relative economic cost associated with routing the request to each of the predefined content, the agent, or the community is based at least in part on the assigned complexity score.

13. The system of claim 12, wherein analyzing the request and the user making the request comprises determining a customer lifetime value for the user making the request and assigning a relative importance to the request based on the customer lifetime value.

14. The system of claim 13, wherein routing of customer service questions or requests further comprises:
applying one or more rules to the request based on the complexity score and relative importance assigned to the request;
routing the request to the agent or community based on applying the one or more rules;
determining whether the question has been answered; and
in response to determining the question has not been answered, repeating said applying one or more rules to the request based on the complexity score and relative importance assigned to the request and said routing the request to the agent or community based on applying the one or more rules.

15. The system of claim 14, wherein routing of customer service questions or requests further comprises:
assigning an award value to the request, the award value representing an award to be provided to a user of the community providing an answer to the question of the request, wherein the determined relative economic cost associated with routing the request to the community includes the award value; and
in response to determining to route the request to the community, presenting the question and the award to the users of the community.

16. A computer-readable memory having stored therein a sequence of instructions which, when executed at the processor, causes the processor to route of customer service questions or requests by:
registering each of a plurality of users of a customer relationship management system;
receiving a customer service request from a user of the plurality of users, the customer service request including a question;
analyzing the request and the user making the request, wherein analyzing the request and the user making the request comprises determining a relative economic cost associated with routing the request to each of the predefined content, the agent of the customer relationship management system, or the community comprising at least the registered plurality of users; and
routing the request based on analyzing the request and the user making the request to at least one of predefined content of the customer relationship management system, an agent of the customer relationship management system, or a community comprising at least the registered plurality of users, wherein routing the request comprises routing the request based on the relative economic cost.

17. The computer-readable memory of claim 16, wherein analyzing the request comprises:
determining whether the question is related to the predefined content;
in response to determining the question is related to the predefined content, providing the predefined content in response to the request; and
in response to determining the question is not related to the predefined content, determining a complexity of the question and assigning a complexity score to the request based on the determined complexity of the question and wherein determining the relative economic cost associated with routing the request to each of the predefined content, the agent, or the community is based at least in part on the assigned complexity score.

18. The computer-readable memory of claim 17, wherein analyzing the request and the user making the request comprises determining a customer lifetime value for the user making the request and assigning a relative importance to the request based on the customer lifetime value.

19. The computer-readable memory of claim 18, wherein routing of customer service questions or requests further comprises:
applying one or more rules to the request based on the complexity score and relative importance assigned to the request;
routing the request to the agent or community based on applying the one or more rules;
determining whether the question has been answered; and
in response to determining the question has not been answered, repeating said applying one or more rules to the request based on the complexity score and relative importance assigned to the request and said routing the request to the agent or community based on applying the one or more rules.

20. The computer-readable memory of claim 19, wherein routing of customer service questions or requests further comprises:
assigning an award value to the request, the award value representing an award to be provided to a user of the community providing an answer to the question of the request, wherein the determined relative economic cost associated with routing the request to the community includes the award value; and
in response to determining to route the request to the community, presenting the question and the award to the users of the community.
